(19) United States
(12) Patent Application Publication
(10) Pub. No.: US 2024/0333589 A1
(43) Pub. Date: Oct. 3, 2024

(54) SOFTWARE IMAGE UPDATING FOR PLUGGABLE DEVICE

(71) Applicant: Verizon Patent and Licensing Inc., Basking Ridge, NJ (US)

(72) Inventors: Denis A. Khotimsky, Westborough, MA (US); Gregory K. Sherrill, Herndon, VA (US); Eugene DeFrancisci, Seaford, NY (US); Phillip S. Myers, Flower Mound, TX (US)

(21) Appl. No.: 18/128,316

(22) Filed: Mar. 30, 2023

(51) Int. Cl. H04L 41/082; G06F 8/61; H04L 41/0806

(52) U.S. Cl. CPC H04L 41/082; G06F 8/63; H04L 41/0809

(57) ABSTRACT

An example method includes storing a first software image for a pluggable interface module connected to a network communication device in a first memory region of the network communication device, storing a second software image for the pluggable interface module in a second memory region of the network communication device, programming the pluggable interface module with the first software image from the first memory region of the network communication device responsive to determining the pluggable interface module requires updating, setting a first active indicator for the first software image responsive to validating the programming of the pluggable interface module with the first software image, verifying an operation of the first software image by the pluggable interface module, and responsive to a failure of the verifying the operation of the first software image, programming the pluggable interface module with the second software image from the second memory region.

### BACKGROUND

Network communication devices provide interconnections between different types of networks. For example, in a passive optical network (PON) an optical network unit (ONU) is an example network communication device. A PON is typically based on a point-to-multipoint (P2MP) optical fiber topology, known as an optical distribution network (ODN). An ODN uses fiber and passive components, such as splitters and combiners. A PON system uses the ODN to provide connectivity between a number of central nodes known as Optical Line Termination (OLTs) and a number of premises nodes (known equivalently as Optical Network Units (ONUs) or Optical Network Terminals (ONTs)) using bi-directional wavelength channels.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of a communication system, according to some embodiments.

FIG. 2 is a diagram of a network communication device interfacing with a pluggable interface module, according to some embodiments.

FIG. 3 is a diagram of a memory for a network communication device, according to some embodiments.

FIGS. 4-8 are flow diagrams illustrating example methods for updating a pluggable interface module, according to some embodiments.

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of computing scenarios in which the disclosed subject matter may be utilized and/or implemented.

According to some embodiments, a method includes storing a first software image for a pluggable interface module connected to a network communication device in a first memory region of the network communication device, storing a second software image for the pluggable interface module in a second memory region of the network communication device, wherein a committed indicator is set for the second software image, programming the pluggable interface module with the first software image from the first memory region of the network communication device responsive to determining the pluggable interface module requires updating, setting, by the network communication device, a first active indicator for the first software image responsive to validating the programming of the pluggable interface module with the first software image, verifying, by the network communication device, an operation of the first software image by the pluggable interface module, and responsive to a failure of the verifying the operation of the first software image, programming, by the network communication device, the pluggable interface module with the second software image from the second memory region of the network communication device.

According to some embodiments, the method includes extracting the first software image from a software bundle including the first software image and a network communication device software image.

According to some embodiments, the method includes programming the network communication device with the network communication device software image.

According to some embodiments, the method includes rebooting the network communication device responsive to the failure of the verifying the operation of the first software image, wherein programming, by the network communication device, the pluggable interface module with the second software image, includes programming, by the network communication device, the pluggable interface module with the second software image during the rebooting of the network communication device.

According to some embodiments, the method includes generating a first unsupported network interface indicator on the network communication device for the first software image responsive to a failure of at least one of the validating the programming of the pluggable interface module or the verifying the operation of the first software image.

According to some embodiments, the method includes determining a type indicator of the pluggable interface module, and selecting the first software image from a library of software images based on the type indicator.

According to some embodiments, storing the first software image in the first memory region includes storing the first software image in the first memory region responsive to detecting the pluggable interface module being plugged into the network communication device.

According to some embodiments, programming the pluggable interface module with the first software image includes programming the pluggable interface module with the first software image responsive to processing an activate command in the network communication device for the first software image.

According to some embodiments, a system includes a non-volatile memory having a first memory region and a second memory region, a first connector that is pluggable with a pluggable interface module connector, and a processor configured to program the pluggable interface module with a first software image stored in the first memory region responsive to determining the pluggable interface module requires updating, set a first active indicator for the first software image responsive to validating the programming of the pluggable interface module with the first software image, verify an operation of the first software image by the pluggable interface module, and responsive to a failure of the verifying the operation of the first software image, program the pluggable interface module with a second software image stored in the second memory region.

According to some embodiments, the processor is configured to extract the first software image from a software bundle including the first software image and a network communication device software image.

According to some embodiments, the processor is configured to program the network communication device with the network communication device software image.

According to some embodiments, the processor is configured to facilitate a reboot operation responsive to the failure of the verifying the operation of the first software image, wherein programming the pluggable interface module with the second software image, includes programming the pluggable interface module with the second software image during the reboot operation.

According to some embodiments, the processor is configured to generate a first unsupported network interface indicator for the first software image responsive to a failure of at least one of the validating the programming of the pluggable interface module or the verifying the operation of the first software image.

According to some embodiments, the processor is configured to determine a type indicator of the pluggable interface module and the processor is configured to select the first software image from a library of software images based on the type indicator.

According to some embodiments, the processor is configured to store the first software image in the first memory region responsive to detecting the pluggable interface module being plugged into the first connector.

According to some embodiments, the processor is configured to program the pluggable interface module with the first software image responsive to processing an activate command for the first software image.

According to some embodiments, the processor is configured to ignore a version mismatch associated with the first software image responsive to an experimental indicator being set.

According to some embodiments, a system includes a first connector providing a local area network interface, a second connector providing a pluggable interface for a pluggable interface module to a wide area network, a non-volatile memory system having a first portion and a second portion, and a processor configured to receive a software bundle package from the wide area network, extract a first software image for the pluggable interface module from the software bundle package, and store the first software image in the first portion of the non-volatile memory system, wherein the second portion of the non-volatile memory system stores a second software image that has a committed state, and responsive to a trigger event, execute an upgrade procedure to upgrade the pluggable interface module with the first software image, the upgrade procedure including validating the first software image, setting a state of the first software image to active when the first software image has been validated, uploading the first software image to the pluggable interface module when the first software image is in the active state, verifying an operation of the first software image after the uploading of the first software image to the pluggable interface module, and responsive to a failure of the verifying the operation of the first software image, programming the pluggable interface module with the second software image from the second portion.

According to some embodiments, the trigger event includes at least one of an insertion of the pluggable interface module into the second connector or an activate command for the first software image.

According to some embodiments, the local area network interface includes at least one of an optical interface or an Ethernet interface and the pluggable interface module provides an interface to a wide area optical network.

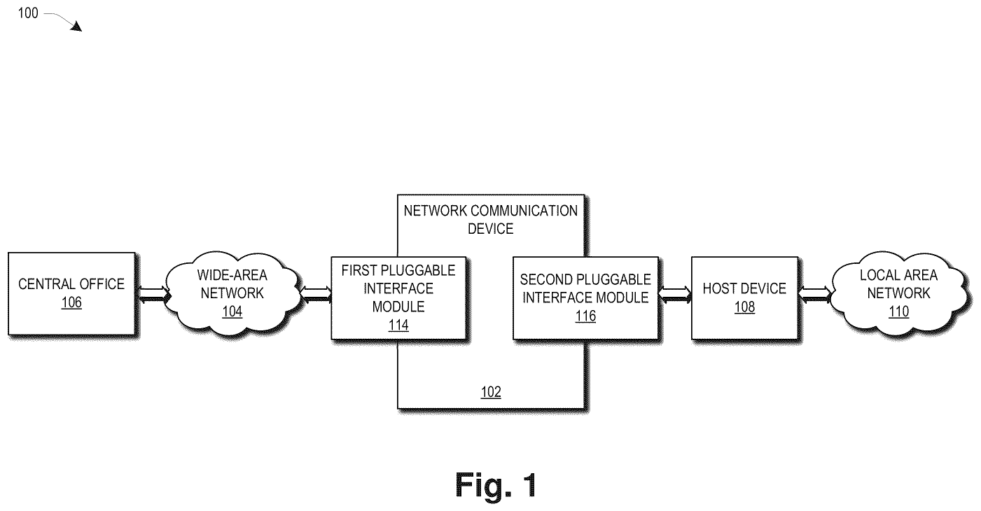

FIG. 1 is a diagram of a communication system 100, according to some embodiments. The communication system 100 comprises a network communication device 102 that communicates between a wide-area network 104, such as a PON, managed by a central office 106 and a host device 108 connected to a local area network 110, such as an Ethernet network. In some embodiments, the first pluggable interface module 114 is network-facing and the second pluggable interface module 116 is premises-facing. The host device 108 and local area network 110 may be part of a customer premises served by the central office 106. The host device 108 may be a router, a modem, a security device, an access point, or some other device that communicates between the local area network 110 and the wide-area network 104.

In some embodiments, the network communication device 102 interfaces with one or more pluggable interface devices to support communication over one or more networks, such as a first pluggable interface module 114 (e.g., an optical pluggable interface module when the wide-area network 104 is a PON), a second pluggable interface module 116 (e.g., an Ethernet pluggable interface module when the local area network 110 is an Ethernet network) multiple such devices, or other pluggable devices. In some embodiments, the network communication device 102 may be employed in applications other than PON to Ethernet. The pluggable interface modules 114, 116 may comprise a small form factor pluggable (SFP) device, a SFP+ device, a 10 gigabit small form factor pluggable (XFP) device, a C form-factor pluggable (CFP) device, or other device.

In some embodiments, the network communication device 102, the first pluggable interface module 114, and/or the second pluggable interface module 116 executes an embedded software image. An embedded software image refers to software developed for a particular device or a component thereof. The term “firmware” refers to a subclass of embedded software having a lower level, more specialized nature.

Embedded software management techniques may employ two non-volatile memory storage regions, where each section is sufficiently large to accommodate a complete embedded software image for the network communication device 102 to operate. At any given moment of time, the network communication device 102 executes an “active” software image from one of the memory regions. The other memory region may be used to store another software image, which may be in any number of states based on an upgrade/update process. This dual memory region configuration enables an upgrade process that allows for rollback to a previous version if the upgraded version of the software image turns out to be is faulty. In some embodiments, once a software image in a memory region is determined to be sufficiently correct, it is placed in a “committed” state, such that upon reboot the network communication device 102 will default to choosing to execute the software image in the committed state. Only one of the two memory regions will be set to the “committed” state, so upon determining that a new software image should be set to “committed,” the other memory region has its state changed.

Whenever a need to upgrade the network communication device 102 embedded software image arises, a new software image is first downloaded into the memory region that does not contain an active image. The downloaded image is then validated in the memory region to ensure no error occurred during download. Subsequently, a two-phase software update procedure is applied that comprises the first step of “activating” the software image, whereby the newly downloaded software image is executed and subjected to functional checks to test for proper performance, and the second step of “committing” the image, whereby the newly downloaded and activated software image is specified as the default image that is to be run on future reboots of the network communication device 102. If before the newly downloaded and activated software image is committed, any functional check fails and/or normal communication with the network communication device 102 is interrupted, rebooting the NCD either manually or automatically would cause the network communication device 102 to use the original (previously “committed”) software image, thus rolling back the effect of the attempted software upgrade.

In some embodiments, the network communication device 102 is a compound device in that the pluggable interface modules 114, 116 each have their own embedded software image (e.g., firmware), but may only support a single nonvolatile memory region, so any upgrade will irreversibly alter the existing firmware operation of the pluggable interface module 114, 116. To avoid a failed upgrade to the pluggable interface module 114, 116 from rendering the pluggable interface module 114, 116 inoperable, the network communication device 102 may include facilities to manage the upgrading of the pluggable interface modules 114, 116 in a more resilient manner, as further described herein.

The network communication device 102 may receive a software image for the pluggable interface module 114, 116 to be upgraded. In some embodiments, the software image for the pluggable interface module 114, 116 may be included in a bundle with an upgrade software image for the network communication device 102. In some embodiments, the central office 106 sends the software image or bundled software image to the network communication device 102. Where multiple types of pluggable interface modules 114, 116 are supported by the network communication device 102, a library of software images may be provided, and the network communication device 102 may select the appropriate software image for the particular pluggable interface module 114, 116 to be upgraded.

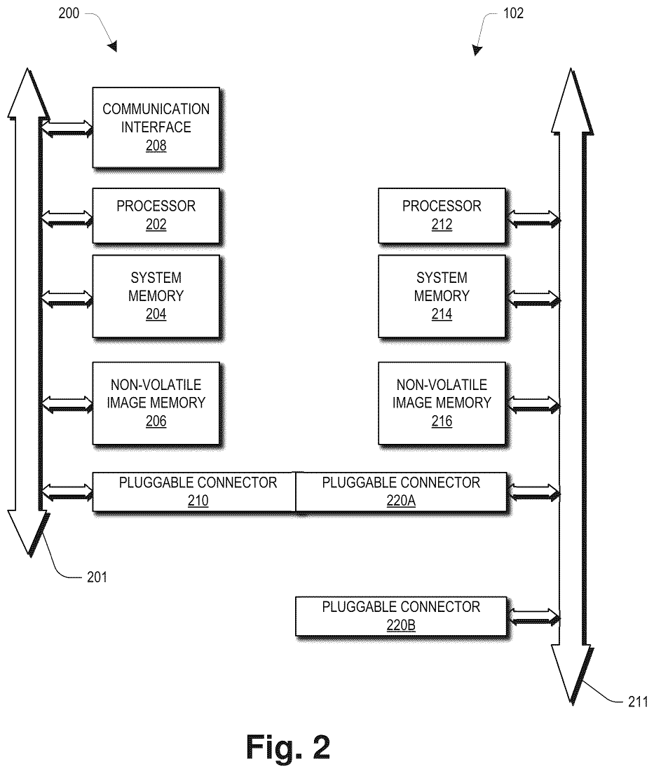

FIG. 2 is a diagram of the network communication device 102 interfacing with a pluggable interface module 200, such as one of the pluggable interface modules 114, 116, according to some embodiments. In some embodiments, the pluggable interface module 200 comprises a bus 201, a processor 202, a system memory 204, a non-volatile image memory 206, a communication interface 208, and a pluggable connector 210. In some embodiments, the network communication device 102 comprises a bus 211, a processor 212, a system memory 214, a non-volatile image memory 216, and pluggable connectors 220A, 220B. The number of pluggable connectors 220A, 220B may vary depending on the number of pluggable devices supported by the network communication device 102. For example, the pluggable interface module 114 may be inserted into the pluggable connector 220A to provide optical network support using an instance of the communication interface 208, and the pluggable interface module 116 may be inserted into the pluggable connector 220B to provide Ethernet network support using an instance of the communication interface 208. The pluggable interface module 200 and the network communication device 102 may include fewer components, additional components, different components, and/or a different arrangement of components than those illustrated in FIG. 2.

According to some embodiments, the buses 201, 211 include paths that permits communication among the components of the pluggable interface module 200 and the network communication device 102, respectively. For example, the bus 201, 211 may include a system bus, an address bus, a data bus, and/or a control bus. The bus 201, 211 may also include bus drivers, bus arbiters, bus interfaces, and so forth. The processors 202, 212 includes one or multiple processors, microprocessors, data processors, co-processors, such as a mathematics coprocessor or an integrated graphical processing unit (GPU), one or more layers of local cache memory, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processors 202, 212 may be implemented as hardware (e.g., a microprocessor, etc.), a combination of hardware and software (e.g., a SoC, an ASIC, etc.), may include one or multiple memories (e.g., cache, etc.), etc. The processors 202 may be different than the processor 212. For example, the processor 212 may have increased functionality compared to the processor 202.

In some embodiments, the system memories 204, 214 each includes one or multiple memories and/or one or multiple other types of storage mediums. For example, the system memories 204, 214 may include one or multiple types of memories, such as, random access memory (RAM), dynamic random access memory (DRAM), cache, read only memory (ROM), programmable read only memory (PROM), static random access memory (SRAM), flash memory, and/or some other suitable type of memory. The system memories 204, 214 may include a hard disk, a magnetic disk, an optical disk, a magneto-optic disk, a solid state disk, a Micro-Electromechanical System (MEMS)-based storage medium, a nanotechnology-based storage medium, and/or some other suitable disk. The system memories 204, 214 may include drives for reading from and writing to the storage medium. The system memories 204, 214 may be external to and/or removable, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). The system memories 204, 214 may store data, software, and/or instructions. The system memory 204 may differ in type and capacity compared to the system memory 214.

The non-volatile image memories 206, 216 store software images for use by the processors 202, 212 of the pluggable interface module 200 and the network communication device 102, respectively. The non-volatile image memories 206, 216 retain data even if power is removed. The non-volatile image memories 206, 216 may include PROM, flash memory, phase-change memory (PCM), resistive memory (ReRAM), magneto-resistive memory (MRAM), ferroelectric memory (FeRAM), or some other type of non-volatile memory. The non-volatile image memories 206, 216 may span multiple physical memory devices. Although the system memories 204, 214 may include non-volatile memory, the system memories 204, 214 and the non-volatile image memories 206, 216 are distinguished by the type of data stored rather than the memory topology. In some embodiments, the non-volatile image memories 206, 216 may be predefined regions of the system memories 204, 214. The non-volatile image memories 206, 216 may differ from one another in type and/or capacity. For example, the non-volatile image memory 216 may have a greater capacity than the non-volatile image memory 206.

In some embodiments, the processors 202, 212 controls the overall operation or a portion of the operation(s) of the pluggable interface module 200 and the network communication device 102, respectively. The processors 202, 212 perform one or multiple operations based on an operating system and/or various applications or computer programs (e.g., software). In some embodiments, the processors 202, 212 use an execute-in-place (XIP) technique to execute software images directly from the respective non-volatile image memory 206, 216 as opposed to copying the software images to the respective system memories 204, 214 during a startup or boot process and executing the software images from the respective system memories 204, 214.

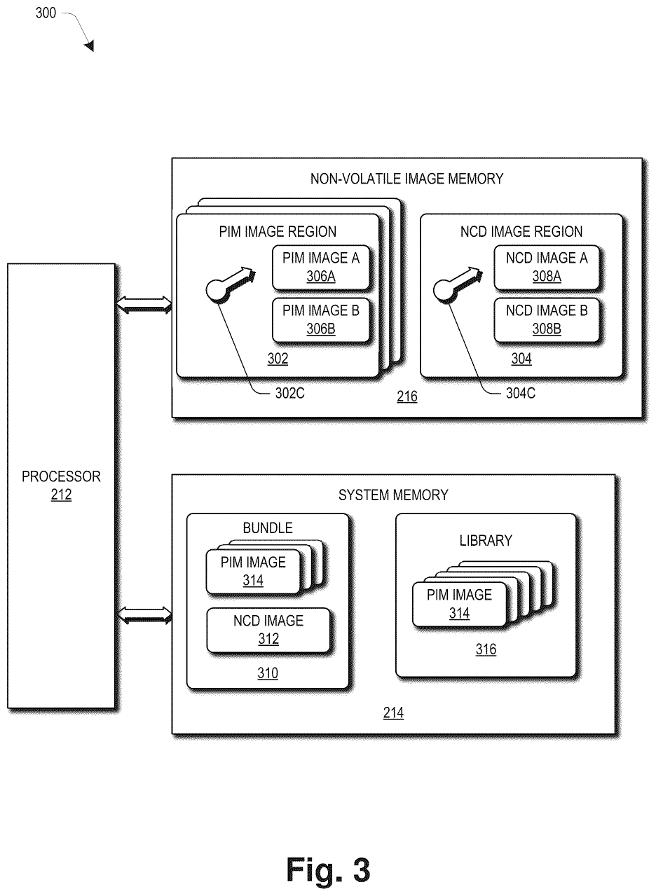

FIG. 3 is a diagram of a memory arrangement 300 for the network communication device 102, according to some embodiments. The non-volatile image memory 216 includes one or more pluggable interface module (PIM) image regions 302 for storing software images for the supported pluggable interface modules 114, 116 and one or more network communication device (NCD) regions 304 for storing software images for the network communication device 102. The number of PIM image regions 302 may correspond to the number of pluggable connectors 220A, 220B in the network communication device 102. Each PIM image region 302 may store an NID image A 306A and an PIM image B 306B. Only one of the PIM images 306A, 306B is indicated as having a committed state at a given time, as designated by a committed indicator 302C (e.g., flag). The PIM image 306A, 306B having the committed state may represent a known operational version of the NID software. The PIM image region 302 that does not contain an image 306 in the committed state may provide a region to store an upgrade version of the NID software, which may become the committed NID image after validation and operational verification (as described herein). The NCD image regions 304 may store an NCD image A 308A and an NCD image B 308B. Only one of the NCD images 308A, 308B is indicated as having a committed state at a given time, as designated by a committed indicator 304C. The NCD image region 304 that does not contain an image 308 in the committed state may provide a region to store an upgrade version of the NCD software, which may become the committed NCD image after validation and operational verification.

The system memory 214 may store a bundle 310 that includes an NCD image 312 and one or more NID images 314. For example, the central office 106 may send the bundle 310 and instruct the network communication device 102 to upgrade the software images for the pluggable interface modules 114, 116 and/or for the network communication device 102. In some embodiments, the bundle 310 may be preloaded in the system memory 214. The network communication device 102 may extract the NCD image 312 or the NID image 314 from the bundle 310 and perform an upgrade process to store, activate, and commit the upgraded software image in the appropriate PIM image region 302 or NCD image region 304 in the non-volatile image memory 216. For example, the network communication device 102 may extract the NID image 314 from the bundle 310 and write over the uncommitted one of PIM image A 306A or PIM image B 306B. In some embodiments, in a case where both the pluggable interface module 200 and the network communication device 102 require updating, the network communication device 102 may be updated using a two-phase update process after the two-phase update process is completed for the pluggable interface module 200.

In some embodiments, the system memory 214 stores a library 316 of NID images 314. The NID images 314 in the library 316 may be preloaded in the system memory 214 or received from the central office 106. As new bundles 310 are received, the NID images 314 may be extracted and stored in the library 316. In some embodiments, each NID image 314 has an associated version number and device type field.

When upgrading a pluggable interface module 200, the network communication device 102 may select the NID image 314 having a device type matching the type associated with the pluggable interface module 200. The network communication device 102 stores the NID image 314 in the appropriate uncommitted PIM image region 302, 304 of the non-volatile image memory 216 and uploads the NID image 314 to the non-volatile image memory 206 of the pluggable interface module 200 for validation and operational verification. Uploading the NID image 314 to the pluggable interface module 200 may be accomplished according to the procedure defined by the manufacturer of the pluggable interface module 200. For example, pluggable interface modules 200 that use SFP form factors may utilize the I2C serial communication interface defined according to the SFP specification.

The network communication device 102 manages the two-phase software upgrade procedure for the pluggable interface module 200 being upgraded. If a failure occurs during an upgrade when trying to activate a new software image, the network communication device 102 can roll back to the previously committed software image and report the failure. In some implementations, the network communication device 102 uses event handlers that respond to appropriate trigger events. For example, event handlers may respond to events such as a NID insertion, an activation command for an uncommitted software image, a reboot, an activation command for a committed software image, a NID extraction, or some other event.

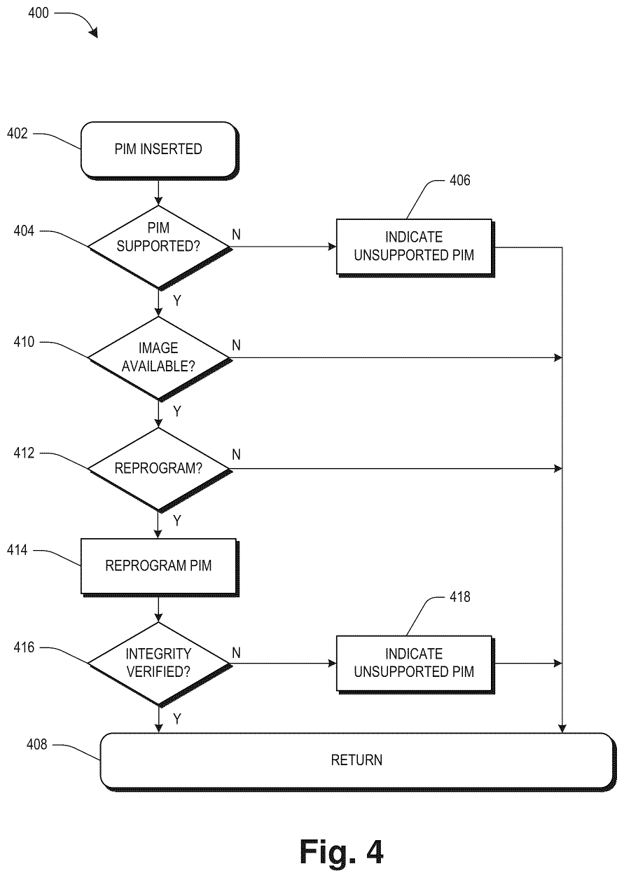

FIGS. 4-8 are flow diagrams illustrating example methods for updating a pluggable interface module, according to some embodiments. The methods of FIGS. 4-8 correspond to example event handlers implemented by the network communication device 102. The trigger events may occur asynchronously. When each type of trigger event occurs, the control is handed over to the corresponding event handler which, upon completion, returns control to the point where the event handler has been invoked.

Referring to FIG. 4, a flow diagram illustrating a method 400 implemented by an event handler invoked upon insertion of a pluggable interface module 200, in accordance with some embodiments. At 402, an insertion of a pluggable interface module 200 is detected. In some embodiments, the insertion may be detected by the network communication device 102 based on a signal received at the pluggable connector 220A, such as a high voltage or a low voltage at a specific pin.

At 404, the network communication device 102 determines whether the inserted pluggable interface module 200 is supported. Support may be checked by sending a request over the pluggable connector 220A to the pluggable connector 210 to obtain identification information, such as manufacturer, model number, and serial number, information from the pluggable interface module 200, and comparing the identification information with a registry of supported NID types, which may be stored in the library 316. In some embodiments, the decision at 404 can be forced to TRUE if a configuration indicator in the network communication device 102 is set requiring that any pluggable interface module 200 of any type be cleared to work with the network communication device 102. This configuration indicator may be referred to as “Any NID” flag.

If the pluggable interface module 200 is not supported at 404, the network communication device 102 indicates an unsupported NID at 406 and returns at 408 to terminate the event handler. The nature of the indication at 406 depends on the output capability of the network communication device 102. For example, the indication may be an alert tone, an LED indicator (e.g., on, off, flashing, multicolored, etc.), a message provided on a display, a message sent to another device, or some other type of indication.

If the pluggable interface module 200 is supported at 404, the network communication device 102 determines if a software image is available for the pluggable interface module 200 at 408. The network communication device 102 may determine availability by looking at PIM image regions 302, the bundles 310, or the library 316 based on the NID type. A pluggable interface module 200 of the NID type which is not included into the registry of supported types, but is cleared to work by setting the “Any PIM” configuration flag, would necessarily have no software image available. If no software image is available at 410, the network communication device 102 returns at 408 to terminate the event handler. If the software image is not currently stored in PIM image regions 302, the network communications device 102 may store the image in a region associated with the NID. For example, the network communications device 102 may copy the identified software image to the PIM image region 302 in non-volatile image memory 216 that is associated with the pluggable connector 220A occupied by the pluggable interface module 200. The storage may be to a region 302 that does not contain an image 306 that is in the committed state.

If a software image is available at 408, the network communication device 102 determines whether the pluggable interface module 200 requires reprogramming at 412. The need for reprogramming may be determined by comparing version identifiers of the software image version stored in the non-volatile image memory 206 of the pluggable interface module 200 with the version identifier of the software image identified at 408 and determining if there is a version mismatch. For example, if the version number of the software image in the pluggable interface module 200 does not match the version of the software image stored in PIM image region 302 and indicated as being the active software image, reprogramming is required. In some embodiments, the need for reprogramming may also be triggered by detecting that the installed software image of the pluggable interface module 200 is faulty, such as may be indicated by a lack of accessibility or the contents of a certain memory location in the pluggable interface module 200. For one NID type, this condition may be checked by attempting to obtain the firmware version information from the pluggable interface module 200. If the most recent firmware programming session has been successful, the firmware version would available, while if the most recent firmware programming session failed, leaving the pluggable interface module 200 in an inconsistent state, the firmware version information would be unavailable. In some embodiments, the network communication device 102 may store a “configuration flag” indicating that version mismatches should be ignored, or that version mismatches should only be checked by a subset of the event handlers in the situations requiring the use of an out-of-the box pluggable interface module 200 with manufacturer-installed firmware. This configuration flag may also be referred to as an “Experimental Firmware” flag. If reprogramming is not required at 412, the network communication device 102 returns at 408 to terminate the event handler.

If the pluggable interface module 200 requires reprogramming at 412, the network communication device 102 reprograms the pluggable interface module 200 at 414 by uploading the identified software image to the non-volatile image memory 206 of the pluggable interface module 200, thereby overwriting its previous contents. If not already present, the identified software image is copied to the non-volatile image memory 216 of the network communication device 102 in the PIM image region 302 associated with the pluggable connector 220A occupied by the pluggable interface module 200 in the inactive one of PIM image A 306A or PIM image B 306 locations. At 416, the network communication device 102 verifies the integrity of the software image uploaded to the non-volatile image memory 206 of the pluggable interface module 200. In some embodiments, evaluation of integrity is done continuously while the software image is written in the non-volatile image memory 206 of the pluggable interface module 200 (e.g., through various integrity checking and/or handshaking techniques), and a successful update may be determined once the entire software image is written without errors. In some implementations, faults of intermediate integrity checks may trigger a number of retry attempts. A failure of the software image installation integrity will leave the pluggable interface module 200 in a state that at any later point in time would fail the software image consistency verification. If the integrity verification fails at 416, the network communication device 102 indicates an unsupported NID at 418 and returns at 408 to terminate the event handler. The type of indication provided at 418 may be different than the indication provided at 406, such as a different message or LED pattern. If the integrity verification passes at 416, the network communication device 102 returns at 408. In some embodiments, the status of the PIM image A 306A or PIM image B 306B where the software image was stored remains inactive.

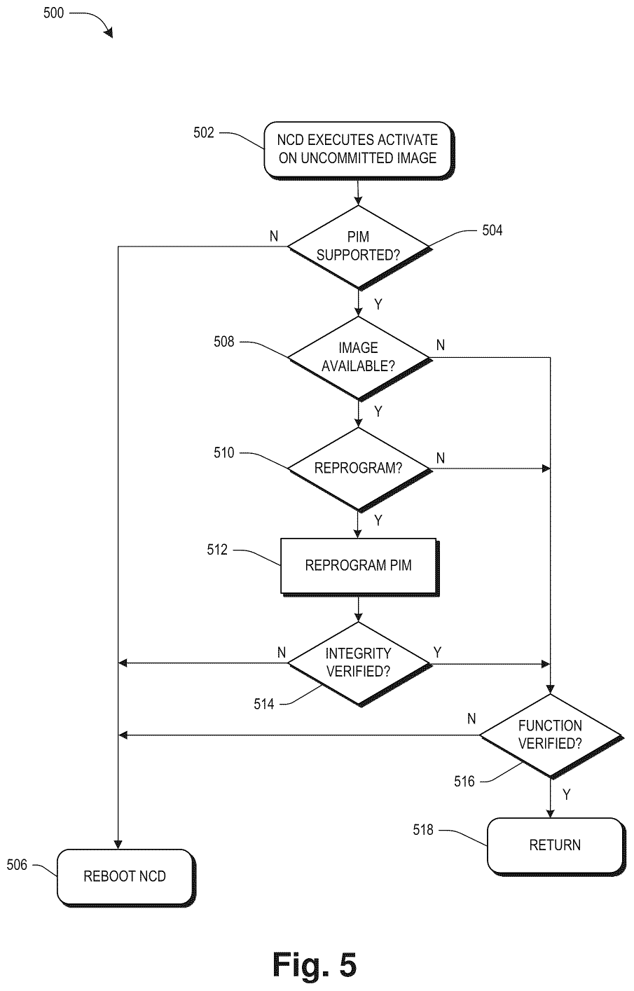

Referring to FIG. 5, a flow diagram illustrating a method 500 implemented by an event handler invoked upon execution of an activate command on an uncommitted image, in accordance with some embodiments. At 502, execution of an activate command on an uncommitted image is detected.

At 504, the network communication device 102 determines whether the inserted pluggable interface module 200 is supported. Support may be checked by sending a request over the pluggable connector 220A to the pluggable connector 210 to obtain identification information, such as manufacturer, model number, and serial number, information from the pluggable interface module 200, and comparing the identification information with a registry of supported NID types, which may be stored in the library 316. In some embodiments, the decision at 504 can be forced to TRUE if the “Any NID” flag is set. If the pluggable interface module 200 is not supported at 504, the network communication device 102 reboots at 516.

If the pluggable interface module 200 is supported at 504, the network communication device 102 determines if a software image is available for the pluggable interface module 200 at 508. The network communication device 102 may determine availability by looking at PIM image regions 302, the bundles 310, or the library 316 based on the NID type. A pluggable interface module 200 of the NID type which is not included into the registry of supported types, but is cleared to work by setting the “Any PIM” configuration flag, would necessarily have no software image available.

If a software image is available at 508, the network communication device 102 determines whether the pluggable interface module 200 requires reprogramming at 510. The need for reprogramming may be determined by comparing version identifiers of the software image version stored in the non-volatile image memory 206 of the pluggable interface module 200 with the version identifier of the software image identified at 508 and determining if there is a version mismatch. In some embodiments, the need for reprogramming may also be triggered by detecting that the installed software image of the pluggable interface module 200 is faulty, such as may be indicated by a lack of accessibility or the contents of a certain memory location in the pluggable interface module 200. For one NID type, this condition may be checked by attempting to obtain the firmware version information from the pluggable interface module 200. If the most recent firmware programming session has been successful, the firmware version would available, while if the most recent firmware programming session failed, leaving the pluggable interface module 200 in an inconsistent state, the firmware version information would be unavailable. In some embodiments, the network communication device 102 may store a “configuration flag” indicating that version mismatches should be ignored, or that version mismatches should only be checked by a subset of the event handlers in the situations requiring the use of an out-of-the box pluggable interface module 200 with manufacturer-installed firmware. This configuration flag may also be referred to as an “Experimental Firmware” flag.

If the pluggable interface module 200 requires reprogramming at 512, the network communication device 102 reprograms the pluggable interface module 200 at 512 by copying the identified software image to the non-volatile image memory 216 of the network communication device 102 in the PIM image region 302 associated with the pluggable connector 220A occupied by the pluggable interface module 200 in the inactive one of PIM image A 306A or PIM image B 306 locations. The network communication device 102 also uploads the identified software image to the non-volatile image memory 206 of the pluggable interface module 200, overwriting its previous contents.

At 514, the network communication device 102 verifies the integrity of the software image uploaded to the non-volatile image memory 206 of the pluggable interface module 200. In some embodiments, evaluation of integrity is done continuously while the software image is written in the non-volatile image memory 206 of the pluggable interface module 200 (e.g., through various integrity checking and/or handshaking techniques), and a successful update may be asserted once the entire software image is written without errors. In some implementations, faults of intermediate integrity checks may trigger a number of retry attempts. A failure of the software image installation integrity will leave the pluggable interface module 200 in a state that at any later point in time would fail the software image consistency verification. If the integrity verification fails at 514, the network communication device 102 reboots at 506. If the integrity verification passes at 514, the network communication device 102 sets the active flag for the one of PIM image A 306A or PIM image B 306B locations where the software image is stored and sets the commit flag for the previous version of the software image.

If there is no software image available at 508, there is no need to reprogram at 510, or if the integrity passes at 514, the network communication device 102 verifies the function of the pluggable interface module 200 at 516. In some embodiments, functional verification is performed by evaluating the operation of the pluggable interface module 200 using the upgraded software image. The network communication device 102 may include one or more self-evaluation functional check routines, such as establishing communication over the communication interface 208 of the pluggable interface module 200.

If the functional verification of the pluggable interface module 200 passes at 516, the network communication device 102 returns at 518. If the functional verification of the pluggable interface module 200 fails at 516, the network communication device 102 reboots at 506.

In some embodiments, the central office 106 may send a command to the network communication device 102 to commit the software image after functional verification. The network communication device 102 may send a message to the central office 106 to indicate successful functional verification.

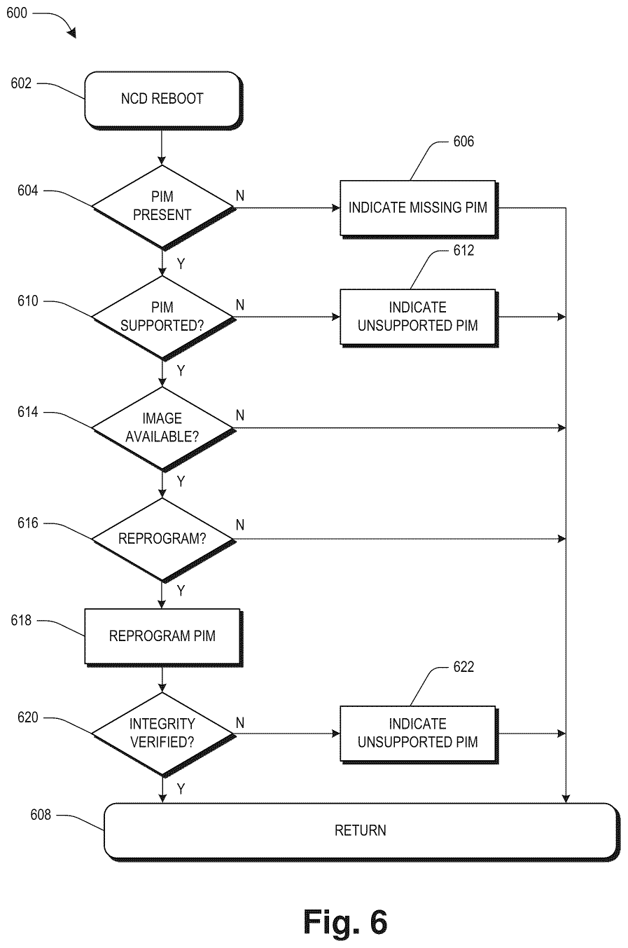

Referring to FIG. 6, a flow diagram illustrating a method 600 implemented by an event handler invoked upon a reboot of the network communication device 102, in accordance with some embodiments. At 602, the reboot occurs. At 604, the network communication device 102 determines whether the pluggable interface module 200 is present. In some embodiments, the presence may be detected by the network communication device 102 based on a signal received at the pluggable connector 220A, such as a high voltage or a low voltage at a specific pin.

If the pluggable interface module 200 is not present at 604, the network communication device 102 indicates a missing NID at 606 and returns at 608 to terminate the event handler. The indication at 606 may differ (e.g., a different message or LED pattern) from those used for an unsupported NID or an integrity verification failure.

At 614, the network communication device 102 determines whether the inserted pluggable interface module 200 is supported. Support may be checked by sending a request over the pluggable connector 220A to the pluggable connector 210 to obtain identification information, such as manufacturer, model number, and serial number, information from the pluggable interface module 200, and comparing the identification information with a registry of supported NID types, which may be stored in the library 316. In some embodiments, the decision at 614 can be forced to TRUE if the “Any NID” flag is set.

If the pluggable interface module 200 is not supported at 610, the network communication device 102 indicates an unsupported NID at 612 and returns at 608 to terminate the event handler.

If the pluggable interface module 200 is supported at 610, the network communication device 102 determines if a software image is available for the pluggable interface module 200 at 612. The network communication device 102 may determine availability by looking at PIM image regions 302, the bundles 310, or the library 316 based on the NID type. A pluggable interface module 200 of the NID type which is not included into the registry of supported types, but is cleared to work by setting the “Any PIM” configuration flag, would necessarily have no software image available. If no software image is available at 612, the network communication device 102 returns at 608 to terminate the event handler.

If a software image is available at 614, the network communication device 102 determines whether the pluggable interface module 200 requires reprogramming at 616. The need for reprogramming may be determined by comparing version identifiers of the software image version stored in the non-volatile image memory 206 of the pluggable interface module 200 with the version identifier of the software image identified at 614 and determining if there is a version mismatch. If the version of the software image in the pluggable interface module 200, does not match the version of the committed software image in the network communication device 102 as designated by the committed indicator 302D, the committed version is identified as the software image for reprogramming. In some embodiments, the need for reprogramming may also be triggered by detecting that the installed software image of the pluggable interface module 200 is faulty, such as may be indicated by a lack of accessibility or the contents of a certain memory location in the pluggable interface module 200. For one NID type, this condition may be checked by attempting to obtain the firmware version information from the pluggable interface module 200. If the most recent firmware programming session has been successful, the firmware version would available, while if the most recent firmware programming session failed, leaving the pluggable interface module 200 in an inconsistent state, the firmware version information would be unavailable. In some embodiments, the network communication device 102 may store a “configuration flag” indicating that version mismatches should be ignored, or that version mismatches should only be checked by a subset of the event handlers in the situations requiring the use of an out-of-the box pluggable interface module 200 with manufacturer-installed firmware. This configuration flag may also be referred to as an “Experimental Firmware” flag. If reprogramming is not required at 616, the network communication device 102 returns at 608 to terminate the event handler.

If the pluggable interface module 200 requires reprogramming at 616, the network communication device 102 reprograms the pluggable interface module 200 at 618 by uploading the identified software image to the non-volatile image memory 206 of the pluggable interface module 200, overwriting its previous contents. The version uploaded to the pluggable interface module 200 may be the previously committed software image stored in the non-volatile image memory 216 of the network communication device 102 in the PIM image region 302 associated with the pluggable connector 220A occupied by the pluggable interface module 200 in the committed one of PIM image A 306A or PIM image B 306 locations.

At 620, the network communication device 102 verifies the integrity of the software image uploaded to the non-volatile image memory 206 of the pluggable interface module 200. In some embodiments, evaluation of integrity is done continuously while the software image is written in the non-volatile image memory 206 of the pluggable interface module 200 (e.g., through various integrity checking and/or handshaking techniques), and a successful update may be asserted once the entire software image is written without errors. In some implementations, faults of intermediate integrity checks may trigger a number of retry attempts. A failure of the software image installation integrity will leave the pluggable interface module 200 in a state that at any later point in time would fail the software image consistency verification. If the integrity verification fails at 620, the network communication device 102 indicates an unsupported NID at 622 and returns at 608 to terminate the event handler. The type of indication provided at 622 may be different than the indication provided at 606 or at 612, such as a different message or LED pattern. If the integrity verification passes at 620, the network communication device 102 returns at 608.

Note that following a reboot, the committed software image is programmed into the pluggable interface module 200. The previously activated software image may have been working, but the reboot forces the loading of the committed version. The reboot may have been related to a power failure or an action by a technician. The central office 106, may restore the previously active software image by issuing an activate command on the previously active software image which is still stored in the network communication device 102. This scenario may be avoided by the central office 106 sending an instruction to the network communication device 102 to commit the active version after verification and validation, thereby changing the committed indicator 302C.

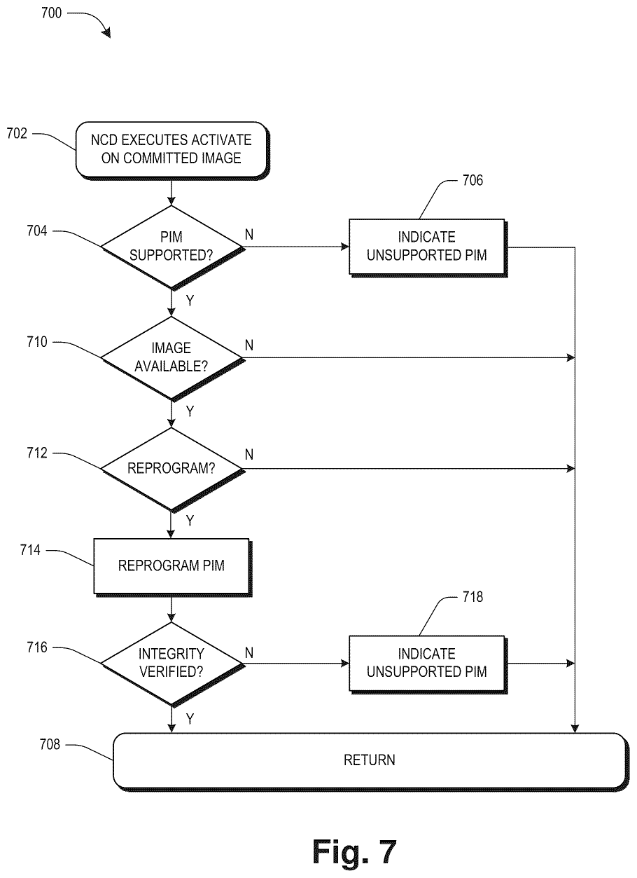

Referring to FIG. 7, a flow diagram illustrating a method 700 implemented by an event handler invoked upon execution of an activate command on a committed image, in accordance with some embodiments. At 702, execution of an activate command on a committed image is detected. In some embodiments, the committed image may activated to force a rollback of the software image in the pluggable interface module 200.

At 704, the network communication device 102 determines whether the inserted pluggable interface module 200 is supported. Support may be checked sending a request over the pluggable connector 220A to the pluggable connector 210 to identification information, such as manufacturer, model number, and serial number, information from the pluggable interface module 200, and comparing the identification information with a registry of supported NID types, which may be stored in the library 316. In some embodiments, the decision at 704 can be forced to TRUE if a configuration flag in the network communication device 102 is set requiring that any pluggable interface module 200 of any type be cleared to work with the network communication device 102. This configuration flag may be referred to as “Any NID” flag.

If the pluggable interface module 200 is not supported at 704, the network communication device 102 indicates an unsupported NID at 706 and returns at 708 to terminate the event handler. The nature of the indication at 706 depends on the output capability of the network communication device 102. For example, the indication may be an alert tone, an LED indicator (e.g., on, off, flashing, multicolored, etc.), a message provided on a display, a message sent to another device, or some other type of indication.

If the pluggable interface module 200 is supported at 704, the network communication device 102 determines if a software image is available for the pluggable interface module 200 at 708. The network communication device 102 may determine availability by looking at PIM image regions 302, the bundles 310, or the library 316 based on the NID type. A pluggable interface module 200 of the NID type which is not included into the registry of supported types, but is cleared to work by setting the “Any PIM” configuration flag, would necessarily have no software image available. If no software image is available at 710, the network communication device 102 returns at 708 to terminate the event handler.

If a software image is available at 708, the network communication device 102 determines whether the pluggable interface module 200 requires reprogramming at 712. The need for reprogramming may be determined by comparing version identifiers of the software image version stored in the non-volatile image memory 206 of the pluggable interface module 200 with the version identifier of the software image identified at 708 and determining if there is a version mismatch. In some embodiments, the need for reprogramming may also be triggered by detecting that the installed software image of the pluggable interface module 200 is faulty, such as may be indicated by a lack of accessibility or the contents of a certain memory location in the pluggable interface module 200. For one NID type, this condition may be checked by attempting to obtain the firmware version information from the pluggable interface module 200. If the most recent firmware programming session has been successful, the firmware version would available, while if the most recent firmware programming session failed, leaving the pluggable interface module 200 in an inconsistent state, the firmware version information would be unavailable. In some embodiments, the network communication device 102 may store a “configuration flag” indicating that version mismatches should be ignored, or that version mismatches should only be checked by a subset of the event handlers in the situations requiring the use of an out-of-the box pluggable interface module 200 with manufacturer-installed firmware. This configuration flag may also be referred to as an “Experimental Firmware” flag. If reprogramming is not required at 712, the network communication device 102 returns at 708 to terminate the event handler.

If the pluggable interface module 200 requires reprogramming at 712, the network communication device 102 uploads the identified software image to the non-volatile image memory 206 of the pluggable interface module 200, overwriting its previous contents.

At 716, the network communication device 102 verifies the integrity of the software image uploaded to the non-volatile image memory 206 of the pluggable interface module 200. In some embodiments, evaluation of integrity is done continuously while the software image is written in the non-volatile image memory 206 of the pluggable interface module 200 (e.g., through various integrity checking and/or handshaking techniques), and a successful update may be asserted once the entire software image is written without errors. In some implementations, faults of intermediate integrity checks may trigger a number of retry attempts. A failure of the software image installation integrity will leave the pluggable interface module 200 in a state that at any later point in time would fail the software image consistency verification. If the integrity verification fails at 716, the network communication device 102 indicates an unsupported NID at 718 and returns at 708 to terminate the event handler. The type of indication provided at 718 may be different than the indication provided at 706, such as a different message or LED pattern. If the integrity verification passes at 716, the network communication device 102 returns at 708.

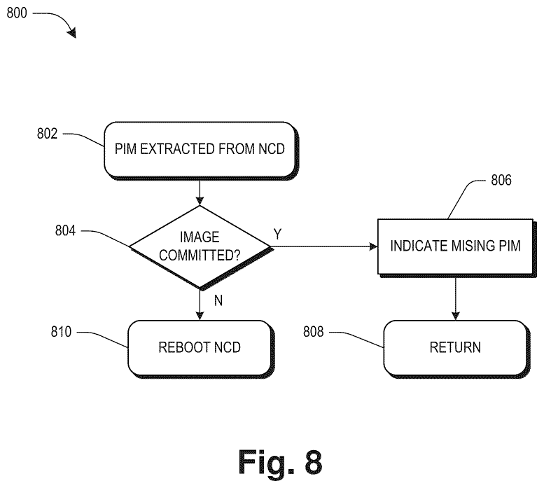

Referring to FIG. 8, a flow diagram illustrating a method 800 implemented by an event handler invoked upon extraction of a pluggable interface module 200, in accordance with some embodiments. At 802, an extraction of a pluggable interface module 200 is detected. In some embodiments, the extraction may be detected by the network communication device 102 based on a signal received at the pluggable connector 220A, such as a high voltage or a low voltage at a specific pin.

At 804, the network communication device 102 determines whether the software image in the PIM image region 302 associated with the pluggable connector 220A occupied by the pluggable interface module 200 in one of PIM image A 306A or PIM image B 306 locations is committed. If the software image is committed at 804, the network communication device 102 indicates a missing NID at 806 and returns at 808 to terminate the event handler. The indication at 806 may differ (e.g., a different message or LED pattern) from those used for an unsupported NID or an integrity verification failure. If the software image is not active and committed at 804, the network communication device 102 reboots at 810.

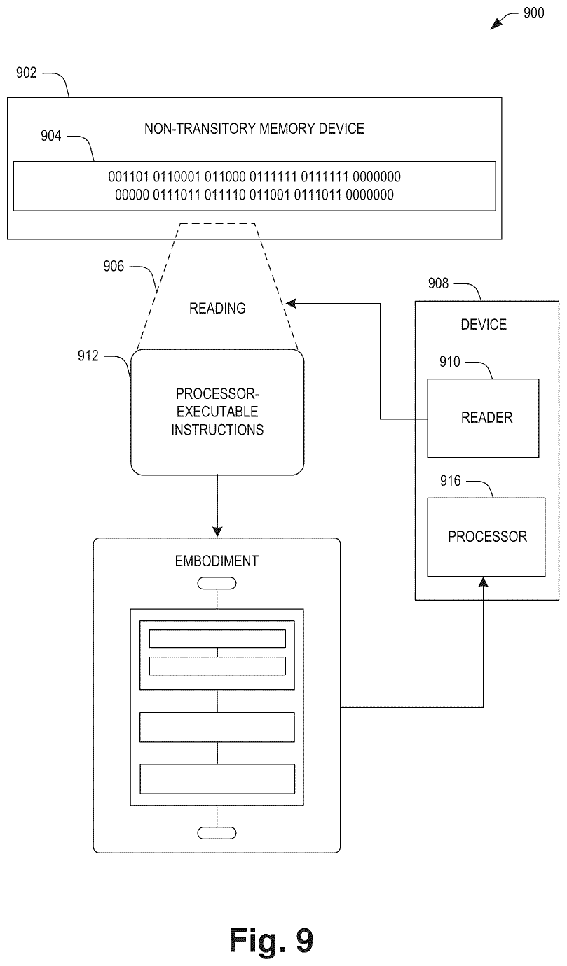

FIG. 9 is an illustration of a scenario 900 involving an example non-transitory machine-readable medium 902. The non-transitory machine readable medium 902 may comprise processor-executable instructions 912 that when executed by a processor 916 cause performance (e.g., by the processor 916) of at least some of the provisions herein. The non-transitory machine readable medium 902 may comprise a memory semiconductor device (e.g., a semiconductor device utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 902 stores machine-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed cause performance of operations, such as at least some of the example methods of FIGS. 4-8, for example. In some embodiments, the processor-executable instructions 912 are configured to cause implementation of a system.

The techniques for managing the updating of the pluggable interface module 200 by the network communication device 102 described herein enable a fault-tolerant, two-phase upgrade procedure for the pluggable interface module 200 allowing upgrading to be conducted in a manner that allows for proper testing and recovery from failed upgrades. In some embodiments, the manufacturers and/or suppliers of the network communication device 102 and the pluggable interface modules 114, 116 may differ. Bundling the software image for the pluggable interface module 114, 116 with the software image for the network communication device 102 reduces the complexity of performing upgrades of the pluggable interface modules 114, 116, since the supplier of the network communication device 102 may test the compatibility and interoperability of the specific versions of each of the software images.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
storing a first software image for a pluggable interface module connected to a network communication device in a first memory region of the network communication device;
storing a second software image for the pluggable interface module in a second memory region of the network communication device, wherein a committed indicator is set for the second software image;
programming the pluggable interface module with the first software image from the first memory region of the network communication device responsive to determining the pluggable interface module requires updating;
setting, by the network communication device, a first active indicator for the first software image responsive to validating the programming of the pluggable interface module with the first software image;
verifying, by the network communication device, an operation of the first software image by the pluggable interface module; and
responsive to a failure of the verifying the operation of the first software image, programming, by the network communication device, the pluggable interface module with the second software image from the second memory region of the network communication device.

2. The method of claim 1, comprising:
extracting the first software image from a software bundle comprising the first software image and a network communication device software image.

3. The method of claim 2, comprising:
programming the network communication device with the network communication device software image.

4. The method of claim 1, comprising:
rebooting the network communication device responsive to the failure of the verifying the operation of the first software image, wherein:
programming, by the network communication device, the pluggable interface module with the second software image, comprises programming, by the network communication device, the pluggable interface module with the second software image during the rebooting of the network communication device.

5. The method of claim 1, comprising:
generating a first unsupported network interface indicator on the network communication device for the first software image responsive to a failure of at least one of:
the validating the programming of the pluggable interface module, or
the verifying the operation of the first software image.

6. The method of claim 1, comprising:
determining a type indicator of the pluggable interface module; and
selecting the first software image from a library of software images based on the type indicator.

7. The method of claim 1, wherein:
storing the first software image in the first memory region comprises storing the first software image in the first memory region responsive to detecting the pluggable interface module being plugged into the network communication device.

8. The method of claim 1, wherein:
programming the pluggable interface module with the first software image comprises programming the pluggable interface module with the first software image responsive to processing an activate command in the network communication device for the first software image.

9. A system, comprising:
a non-volatile memory having a first memory region and a second memory region;
a first connector that is pluggable with a pluggable interface module connector; and
a processor configured to:
program the pluggable interface module with a first software image stored in the first memory region responsive to determining the pluggable interface module requires updating;
set a first active indicator for the first software image responsive to validating the programming of the pluggable interface module with the first software image;
verify an operation of the first software image by the pluggable interface module; and
responsive to a failure of the verifying the operation of the first software image, program the pluggable interface module with a second software image stored in the second memory region.

10. The system of claim 9, wherein:
the processor is configured to extract the first software image from a software bundle comprising the first software image and a network communication device software image.

11. The system of claim 10, wherein:
the processor is configured to program the network communication device with the network communication device software image.

12. The system of claim 9, wherein:
the processor is configured to facilitate a reboot operation responsive to the failure of the verifying the operation of the first software image, wherein:
programming the pluggable interface module with the second software image, comprises programming the pluggable interface module with the second software image during the reboot operation.

13. The system of claim 9, wherein:
the processor is configured to generate a first unsupported network interface indicator for the first software image responsive to a failure of at least one of:
the validating the programming of the pluggable interface module, or
the verifying the operation of the first software image.

14. The system of claim 9, wherein:
the processor is configured to determine a type indicator of the pluggable interface module; and
the processor is configured to select the first software image from a library of software images based on the type indicator.

15. The system of claim 9, wherein:
the processor is configured to store the first software image in the first memory region responsive to detecting the pluggable interface module being plugged into the first connector.

16. The system of claim 9, wherein:
the processor is configured to program the pluggable interface module with the first software image responsive to processing an activate command for the first software image.

17. The system of claim 9, wherein:
the processor is configured to ignore a version mismatch associated with the first software image responsive to an experimental indicator being set.

18. A system, comprising:
a first connector providing a local area network interface;
a second connector providing a pluggable interface for a pluggable interface module to a wide area network;
a non-volatile memory system having a first portion and a second portion; and
a processor configured to:
receive a software bundle package from the wide area network;
extract a first software image for the pluggable interface module from the software bundle package, and store the first software image in the first portion of the non-volatile memory system, wherein the second portion of the non-volatile memory system stores a second software image that has a committed state; and
responsive to a trigger event, execute an upgrade procedure to upgrade the pluggable interface module with the first software image, the upgrade procedure comprising:
validating the first software image,
setting a state of the first software image to active when the first software image has been validated,
uploading the first software image to the pluggable interface module when the first software image is in the active state,
verifying an operation of the first software image after the uploading of the first software image to the pluggable interface module, and
responsive to a failure of the verifying the operation of the first software image, programming the pluggable interface module with the second software image from the second portion.

19. The system of claim 18, wherein the trigger event comprises at least one of:
an insertion of the pluggable interface module into the second connector, or
an activate command for the first software image.

20. The system of claim 18, wherein:
the local area network interface comprises at least one of an optical interface or an Ethernet interface; and
the pluggable interface module provides an interface to a wide area optical network.
